(19) United States
(12) Patent Application Publication
(10) Pub. No.: US 2009/0006391 A1
(43) Pub. Date: Jan. 1, 2009

(54) AUTOMATIC CATEGORIZATION OF DOCUMENT THROUGH TAGGING

(76) Inventor: T REGHU RAM, Tamil Nadu (IN)

Correspondence Address: SAP AG, 3410 HILLVIEW AVENUE, PALO ALTO, CA, 94304, US

(21) Appl. No.: 11/768,907

(22) Filed: Jun. 27, 2007

(51) Int. Cl. G06F 7/02

(52) U.S. Cl. 707/6

(57) ABSTRACT

A system and method for identifying a keyword for tagging a document using a tagging algorithm. The keyword is matching with an existing tag. Irrelevant keywords are rejected based on a relevancy factor. The existing tag is updated based on a feedback.

### FIELD OF TECHNOLOGY

The field of technology relates to the field of textual analysis, and more particularly to a system and method for analyzing and categorizing a document using a tagging algorithm.

### BACKGROUND

The ability to efficiently share and retrieve information on a worldwide scale has become increasingly important as businesses and organizations become more globalized. Information received everyday in the form of an electronic, an internet, a world wide web (WWW), or an electronic document keeps increasing day by day. Often a situation arises where the user must find certain information from a database not remembering an exact keyword or location the information is saved to be searched. For example, categorization of the electronic document based on the context of the electronic document can be done manually. This is done by creating several folders and moving the electronic document to one of the folders based on the context of the document. It is also difficult to organize an electronic mail, or electronic document which also requires manual categorization based on the context of the electronic document. Therefore, there is a need for textual analysis, and more particularly, there is a need for a system and method of analyzing and categorizing a document using a tagging algorithm.

### SUMMARY OF TECHNOLOGY

Embodiments described herein are generally directed to a system and method for identifying a keyword for tagging a document using a tagging algorithm. The keyword is matched with an existing tag. The existing tag is a keyword which is already tagged to a document. Irrelevant keywords are rejected based on a relevancy factor. The existing tag is updated based on a feedback and the document.

### BRIEF DESCRIPTION OF THE DRAWINGS

A better understanding of embodiments of the technology are illustrated by examples and not by way of limitation, the embodiments can be obtained from the following detailed description in conjunction with the following drawings, in which:

FIG. 1 is a flow diagram of a method illustrating an embodiment of the technology.

FIG. 2A and FIG. 2B are exemplary flow diagrams of an embodiment of the technology.

FIG. 3A and FIG. 3B are exemplary display screens displaying an embodiment of the technology.

FIG. 4 is a block diagram illustrating an embodiment of the technology.

### DETAILED DESCRIPTION

Embodiments described herein are generally directed to a system and method for identifying a keyword for tagging a document using a tagging algorithm. The keyword is matched with an existing tag. The existing tag is a keyword which is already tagged to a document. Irrelevant keywords are rejected based on a relevancy factor. The existing tag is updated based on a feedback and the document. The Tagging algorithm helps in searching the document when the user cannot remember the exact keyword or location of the document. Further more, it helps in automatic categorization of the document.

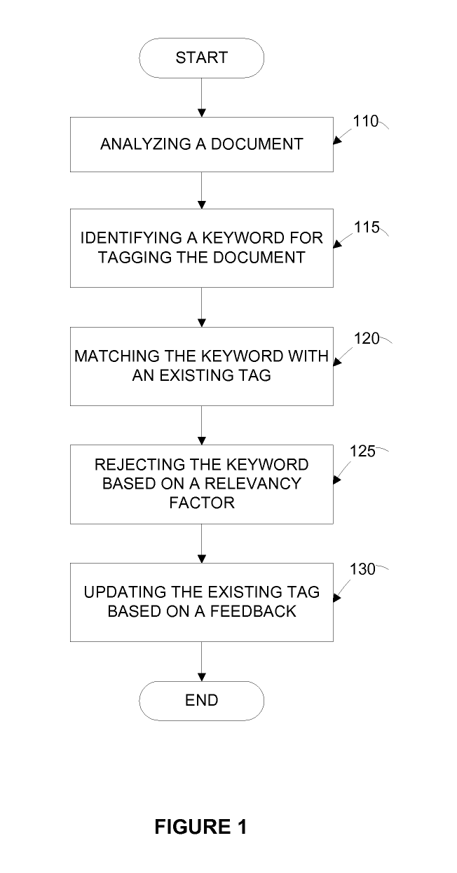

FIG. 1 is a flow diagram of a method illustrating an embodiment of the technology. At process block 110, a document is analyzed. The document may be selected from a set of documents comprising an electronic mail, a voice mail, a short message service (SMS), a multi media service (MMS), a web page, a message, a web feed or an instant messenger message (IM). Analyzing the document may include analyzing each keyword in the document or a set of documents. The documents may be of a similar type or a different type. At process block 115, at least some keywords in the document may be identified for tagging the document using a tagging algorithm. The tagging algorithm may include identifying the keyword with respect to a relevancy factor. The relevancy factor may be selected from a group of factors including a keyword location, a keyword frequency, and a duplicate keyword. Further, tagging the document may include updating an existing tag based on a feedback. The feedback may be provided by the user or the tagging algorithm. Further, the feedback may include a keyword to tag the document with, which could be provided by the user or the tagging algorithm. The document may be tagged with the keyword for having a defined threshold value. The threshold value may be a keyword limit for a desired keyword search result or a number of keyword in the document. The threshold may be calculated from the keyword location, the keyword frequency, and the duplicate keyword. The document is tagged with the keyword whose relevancy factor may be above a threshold value. At process block 120, matching and identifying the keyword with the existing tag is performed using the tagging algorithm. The existing tag may be of any combination including a keyword in the database, a keyword already matched, a keyword provided as feedback, or a keyword identified by the tagging algorithm. At process block 125, a keyword may be rejected based on the relevancy factor using the tagging algorithm. The relevancy factor may be selected from a group of factors including the keyword location, the keyword frequency, and the duplicate keyword. Further, based on the relevancy factor the keyword may be rejected from the existing tag. The database may be selected from any combination but not limited to an electronic mail, a voice mail, a short message service (SMS), a multi media service (MMS), a web page, a message, an instant message (IM), a memory device, a data store medium, or a dictionary. At process block 130, the existing tag is updated based on the feedback. For example, the tagging algorithm matches and identifies the keyword based on the feedback and tags the document. The keyword computed by the tagging algorithm may not be accepted and a relevant keyword may be provided as feedback, which may be used to improve the tagging algorithm.

Preferably, a computer device maintains a database for the existing tag with respect to the document. The tagging algorithm finds the document with similar tags so that the keyword may be used to tag the document. This may help in categorization of similar documents with tags for improving future search. Searching the document which is tagged helps in retrieving the document in a more faster and efficient manner. Further, it helps in automatic categorization of the document than manual categorization.

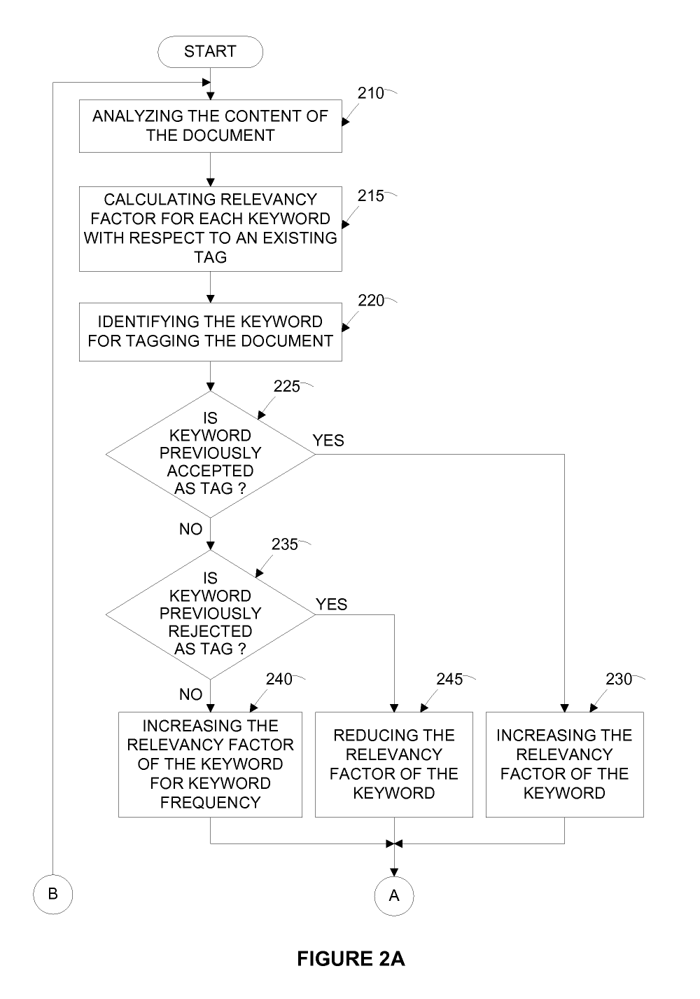

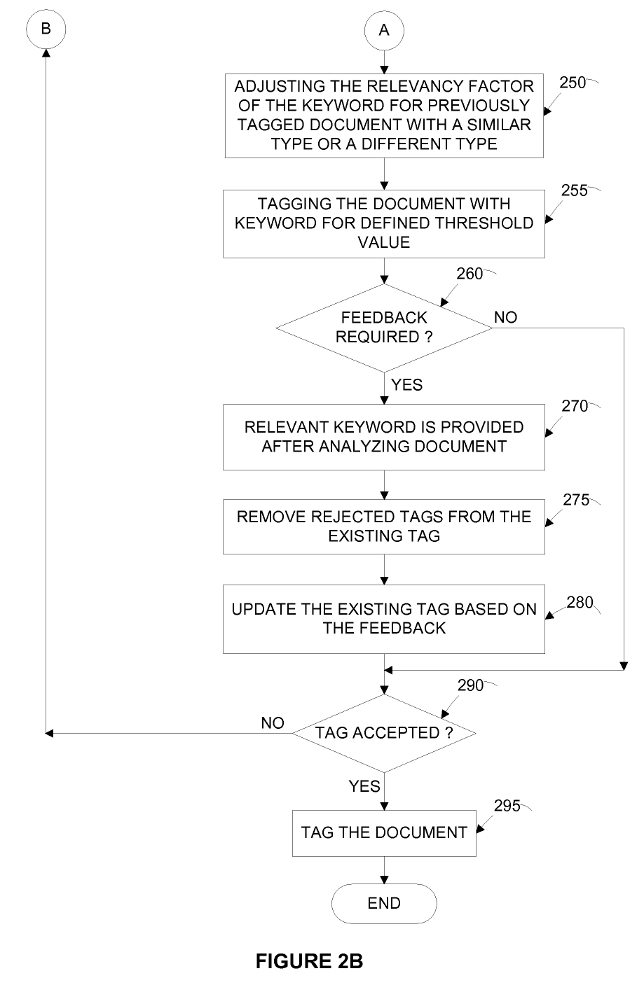

FIG. 2A and FIG. 2B are flow diagrams of an exemplary embodiment of the technology. At process box 210, a content of a document or a set of documents is analyzed. The documents may be of similar types or different types. At process block 215, a relevancy factor for each keyword in the document is calculated with respect to an existing tag. The relevancy factor may be selected from a group of factors including a keyword location, a keyword frequency, and a duplicate keyword. Further, based on the relevancy factor, the keyword may be rejected from the existing tag. At process block 220, the keyword from the document is identified by using the tagging algorithm to tag the document. Identifying the keyword may include computing relevant keywords with respect to the relevancy factor. Matching and identifying the keyword with the existing tag is performed using the tagging algorithm. Further, rejecting the keyword from the document may be based on the tagging algorithm and feedback. The feedback may be provided by the user or the tagging algorithm. Further, the feedback may include the keyword to tag the document provided by the user or the tagging algorithm. The tagging algorithm may include a relevancy factor for computing categorization of the document through tagging. If at decision block 225, the keyword had been previously accepted as a tag then at process bock 230 the relevancy factor of the keyword is increased, otherwise if at decision block 225 the keyword has not been previously accepted as the tag then the system moves to decision block 235. At 235, the keyword may have been previously rejected as the tag then at process block 245 the relevancy factor of the keyword is reduced, otherwise if at decision block 235 the keyword has not been previously rejected as the tag then at process block 240 the relevancy factor of the keyword frequency may be increased. The tag associated with the keyword may already exist in the existing tag database. Based on the outputs received from process block 230, process block 240, or process block 245, at process block 250, the relevancy factor is adjusted for the previously tagged keyword to a document or a set of documents with a similar type or a different type. At process block 255, the document may be tagged with the keyword for a having a defined threshold value. A threshold may be a keyword limit for a desired keyword search result or a number of keyword in the document. The threshold may be calculated from the keyword location, the keyword frequency, and the duplicate keyword. At decision block 260, the feedback is not required for improving the keyword for tagging the document then at process block 290 the document is tagged, else at 290, the tag for tagging the document is not accepted then the document content is analyzed at 210. At block 270, relevant keyword is provided after analyzing the document when the feedback 260 may be required for improving the keyword for tagging the document. At process block 275, the rejected tags are removed from the existing tags. At process block 280, the existing tag is updated based on the feedback. The feedback may be provided by the user or the tagging algorithm. Further, the feedback may include the keyword to tag the document provided by the user or the tagging algorithm. For example, the tagging algorithm matches and identifies the keyword based on the feedback and tags the document. The keyword computed by the tagging algorithm may not be accepted and a relevant keyword may be provided as the feedback, which may be used to improve the tagging algorithm. A computer device maintains the database for the existing tag with respect to the document so that when the tagging algorithm finds the document with similar tags, the keyword may be used to tag the document or from the feedback, which may categorize similar documents with tags for improving future search. At decision block 290, the tag is accepted and at process block 295, the document is tagged.

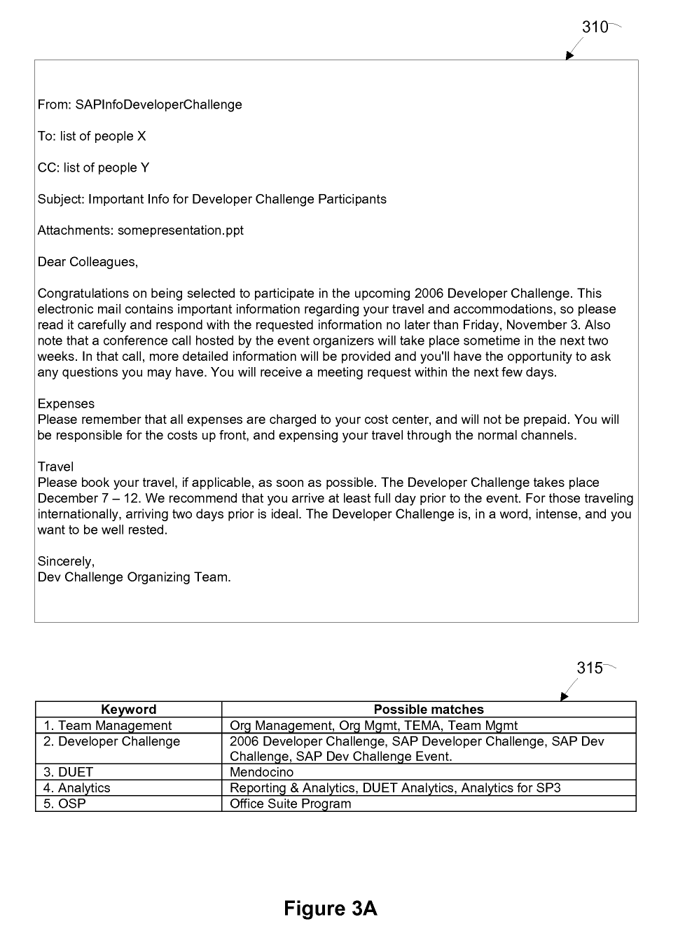

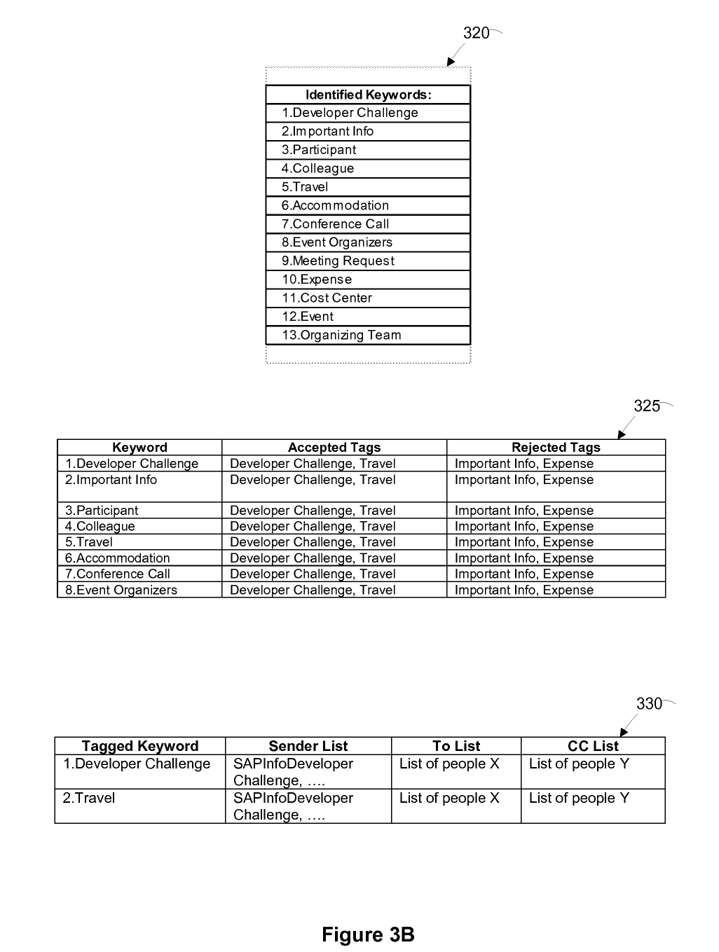

FIG. 3A and FIG. 3B are display screens displaying an exemplary embodiment of the technology. An electronic mail 310 is analyzed (as shown in FIG. 2A, process bock 215). The tagging algorithm may include identifying the keyword with respect to a relevancy factor (as shown in FIG. 2A, process block 220). The relevancy factor may be selected from a group of factors including a keyword location, a keyword frequency (as shown in FIG. 2A, process bock 240), a duplicate keyword (as shown in FIG. 2B, process bock 250), and a keyword threshold (as shown in FIG. 2B, process bock 255). Further, based on the relevancy factor the keyword may be rejected from the existing tag (as shown in FIG. 2B, process block 255). The database may be selected from any combination but not limited to an electronic mail, a voice mail, a short message service (SMS), a multi media service (MMS), a web page, a message, an instant message (IM), a memory device, a data store medium, or a dictionary. At block 315, the tagging algorithm identifies and matches a list of possible keywords for tagging by taking into account (as shown in FIG. 2A, process block 220), for example, the nouns in the electronic mail ranked on the order and number of occurrences in the mail. For example, the keywords in subject are assigned higher precedence over the keywords in the body of the electronic mail. The keywords at certain threshold value are identified. The threshold value is configured such that the larger the threshold value, the smaller the possibility of the system generating irrelevant keywords. The keywords “Team Management Scenario”, “Team Management”, “TEMA” and “Team Mgmt” may all be grouped to refer to the same topic which the user is working on. Tagging the document may include updating an existing tag based on a feedback (as shown in FIG. 2B, process block 280). The feedback may be provided by the user or the tagging algorithm. Further, the feedback may include the keyword to tag the electronic mail with, which could be provided by the user or the tagging algorithm. The document is tagged with the keyword whose relevancy factor is above the threshold value. The database may be selected from any combination but not limited to an electronic mail, a voice mail, a short message service (SMS), a multi media service (MMS), a web page, a message, an instant message (IM), a memory device, a data store medium, or a dictionary. The keyword threshold may be a keyword limit for a desired keyword search result or a number of keyword in the electronic mail. The threshold may be calculated from the keyword Location, the keyword frequency, and the duplicate keyword. At block 320, the keywords are identified using the tagging algorithm for tagging the electronic mail. At block 325, based on the threshold, the tagging algorithm may tag the electronic mail with the keywords, “Developer Challenge”, “Important Info”, “Travel” and “Expense” (as shown in FIG. 2B, decision bock 290). At block 330, the user may accept the keywords “Developer Challenge” and “Travel” to be appropriate tags but rejects the keywords “Important Info” and “Expense” as irrelevant tags (as shown in FIG. 2B, process bock 295). The feedback may be provided by the user or the tagging algorithm. Further, the feedback may include the keyword to tag the electronic mail provided by the user or the tagging algorithm. The keyword computed by the tagging algorithm may not be accepted and a relevant keyword as the feedback may be provided, which may be used to improve the tagging algorithm. A computer device maintains the database for the existing tag with respect to the electronic mail so that when the tagging algorithm finds the electronic mail with similar tags, the keyword may be used to tag the electronic mail or from the feedback, which may categorize similar electronic mail with tags for improving future search.

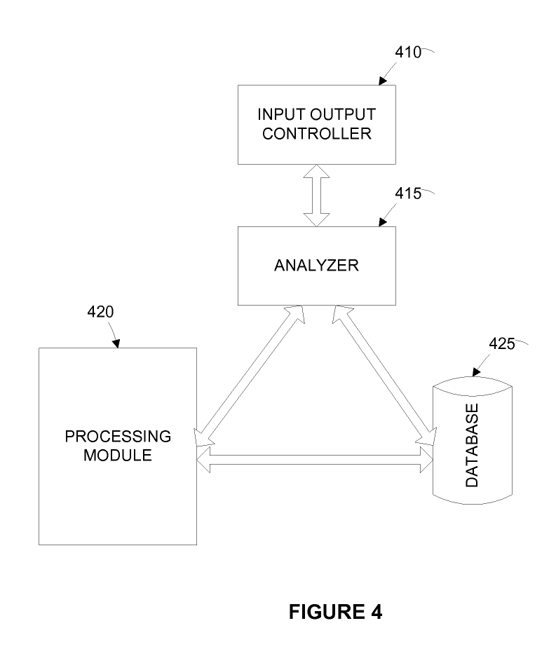

FIG. 4 is a block diagram illustrating an embodiment of the technology. At 410, a document input output controller may receive the document where the document comprising an electronic mail, a voice mail, a short message service (SMS), a multi media service (MMS), a web page, a message or an instant message (IM). The analyzer 415 is electronically coupled to the document input output controller to analyze the document from the document input output controller. Analyzing the document may include analyzing each keyword in the document or the set of documents. The documents may be of a similar type or a different type. Further, the document is classified with the set of documents based on the tagging algorithm. The database 425, is coupled to the analyzer 415. The database may be selected from any combination but not limited to an electronic mail, a voice mail, a short message service (SMS), a multi media service (MMS), a web page, a message, an instant message (IM), a memory device, a data store medium, or a dictionary. The processing module 420, is coupled to the analyzer 415 and the database 425 to analyze the document using a keyword to tag the document based on a tagging algorithm. Each keyword in the document may be identified for tagging the document using a tagging algorithm. The tagging algorithm may include identifying the keyword with respect to a relevancy factor. The relevancy factor may be selected from a group of factors including a keyword location, a keyword frequency, and a duplicate keyword. Further, tagging the document may include updating an existing tag based on a feedback. The feedback may be provided by the user or the tagging algorithm. Further, the feedback may include the keyword to tag the document provided by the user or the tagging algorithm. The existing tag may be of any combination including a keyword in the database, a keyword already matched, a keyword provided as feedback, or a keyword identified by the tagging algorithm. The keyword is rejected based on the relevancy factor using the tagging algorithm. The relevancy factor may be selected from a group of factors including a keyword location, a keyword frequency, a keyword threshold, and a duplicate keyword. Further, based on the relevancy factor the keyword may be rejected from the existing tag. The existing tag is updated in the database 325 based on the feedback. For example, the tagging algorithm matches and identifies the keyword based on the feedback and tags the document. The keyword computed by the tagging algorithm may not be accepted and a relevant keyword as the feedback may be provided, which may be used to improve the tagging algorithm. A computer device maintains the database 325 for the existing tag with respect to the document so that when the tagging algorithm finds the document with similar tags, the keyword may be used to tag the document or from the feedback, which may categorize similar documents with tags for improving future search.

Elements of embodiments of the present technology may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, or other type of machine-readable media suitable for storing electronic instructions.

It should be appreciated that reference throughout this specification to one embodiment or an embodiment means that a particular feature, structure or characteristic described in connection with the embodiment is included in at least one embodiment of the present technology. These references are not necessarily all referring to the same embodiment. Furthermore, the particular features, structures or characteristics may be combined as suitable in one or more embodiments of the technology.

What is claimed is:

1. A computer-implemented method for a tagging algorithm comprising:
analyzing a document;
identifying a keyword for tagging the document;
matching the keyword with an existing tag;
rejecting the keyword based on a relevancy factor; and
updating the existing tag based on a feedback.

2. The method of claim 1, wherein the document comprises a set of documents.

3. The method of claim 2, further comprising classifying the set of documents using the tagging algorithm.

4. The method of claim 1, wherein analyzing the document comprises analyzing the keyword in the document.

5. The method of claim 1, wherein the tagging algorithm comprises identifying the keyword for tagging the document.

6. The method of claim 1, where the tagging algorithm comprises using the relevancy factor.

7. The method of claim 1, wherein the relevancy factor comprises a factor selected from a group of factors consisting of a keyword location, a keyword frequency, and a duplicate keyword.

8. The method claim 1, further comprising adjusting the relevancy factor of the keyword for a previously tagged document with a similar type of document.

9. The method claim 1, further comprising adjusting the relevancy factor of the keyword for a previously tagged document with a different type of document.

10. An article of manufacture for a tagging algorithm, comprising:
an electronically accessible medium including instructions, that when executed by a processor, cause the processor to:
analyze a document;
identify a keyword for tagging the document;
match the keyword with an existing tag;
reject the keyword based on a relevancy factor; and
update the existing tag based on a feedback.

11. The article of claim 10, wherein the document comprises a set of documents.

12. The article of claim 11, further comprising classifying the set of documents using the tagging algorithm.

13. The article of claim 10, wherein analyzing the document comprises analyzing the keyword in the document.

14. The article of claim 10, wherein the tagging algorithm comprises identifying the keyword for tagging the document.

15. The article of claim 10, where the tagging algorithm comprises using the relevancy factor.

16. The article of claim 10, wherein the relevancy factor comprises a factor selected from a group of factors consisting of a keyword location, a keyword frequency, and a duplicate keyword.

17. The article of claim 10, further comprising adjusting the relevancy factor of the keyword for a previously tagged document with a similar type of document.

18. The article of claim 10, further comprising adjusting the relevancy factor of the keyword for a previously tagged document with a different type of document.

19. A system for a tagging algorithm comprising:
a document input output controller;
an analyzer electronically coupled to the document input output controller to analyze a document from the document input output controller;
a database electronically coupled to the analyzer; and
a processing module electronically coupled to the analyzer and the database to analyze the document using a keyword to tag the document using the tagging algorithm.
